(19) United States
(12) Patent Application Publication
(10) Pub. No.: US 2013/0038728 A1
(43) Pub. Date: Feb. 14, 2013

(54) IMAGE-TRANSMITTING APPARATUS HAVING A SECURITY FUNCTION

(71) Applicant: Myung-Hwan Kim, Seoul (KR)

(72) Inventor: Myung-Hwan Kim, Seoul (KR)

(73) Assignee: GUMMI ELECTRONIC CO., LTD, Seoul (KR)

(21) Appl. No.: 13/642,454

(22) PCT Filed: Apr. 14, 2011
(86) PCT No.: PCT/KR11/02651

§ 371 Date: Oct. 19, 2012

(30) Foreign Application Priority Data
Apr. 21, 2010 (KR) 10-2010-0037090

(51) Int. Cl. H04N 7/18

(52) U.S. Cl. 348/143; 348/E07.085

(57) ABSTRACT

An image-transmitting apparatus having a security function is provided. The image-transmitting apparatus having the security function includes a main body which is provided with a wireless or wired interface, a speaker, and an IP camera, either side of which having slide grooves formed in a horizontal direction in the upper and lower portions thereof; and lamp modules having LED lamps and sliders protruding so as to correspond to the respective slide grooves, such that the sliders are inserted into the respective slide grooves in order to couple the lamp modules to either side of the main body, respectively.

### CROSS-REFERENCE TO RELATED APPLICATIONS

This application claims the benefit of Korean Patent Application No. 10-2010-0037090, filed on Apr. 21, 2010 in the Korean Intellectual Property Office, which is incorporated herein by reference in its entirety.

### BACKGROUND OF THE INVENTION

1. Field of the Invention

Exemplary embodiments of the present invention relate to a image transmitting apparatus having a security function, and more particularly, to such a image transmitting apparatus in which lamp modules including LED lamps are slidingly coupled to both sides of a main body including an IP camera.

2. Description of Related Art

Conventionally, a general security system adopts a method operated by a security service company employing a professional security system, i.e., a method in which a central sensing and receiving unit receives signals detected by various sensors, and transmits the received signals to a transmitting unit which in turn informs it to a control room through a dedicated line so that a person doing a security service in the company can be called in, or a method in which an individual security device consisting of a sensor and a control unit is provided so that the security device is connected to a telephone to inform an emergency situation to a related agency, if necessary.

However, such a conventional security system has a limitation in that it should include a separate additional device, and creates an economic burden on a customer because a cost should be paid continuously if the security system is operated on the security service company basis. In addition, the conventional security system also has a limitation in that since it is forcibly connected to an existing telephone being used, if necessary, a problem is caused at the time of mutual matching and a security device should be separately mounted if the security system is operated based on the individual security device that performs a sensing function merely through one sensor.

Meanwhile, since an image security device applied to the conventional security system includes a lamp module integrally mounted at one side of a main body, it irradiates light only in one direction and thus illuminates a narrow area only. In addition, the conventional security system causes an inconvenience in that the entire main body should be removed from a prop on which the image security device is mounted upon the occurrence of a fault in the lamp module so as to repair the faulty lamp module.

In addition, the conventional security system entails a problem in that since light emitted from the lamp module adversely affects the camera, the images captured by the camera are not displayed clearly on a screen.

### SUMMARY OF THE INVENTION

Accordingly, the present invention has been made to solve the above-mentioned problems involved in the conventional prior art, and it is an object of the present invention to provide am image transmitting apparatus having a security function, in which a main body unit including an IP camera and a lamp module are configured separately from each other, and then the lamp module is coupled to both sides of the main body unit in such a manner that the LED lamp is inclined, so that the image-transmitting apparatus can illuminate a large area, the lamp module can be easily separated and repaired upon the occurrence of a fault in the lamp module, and the images captured by the camera are made clear as light emitted by the lamp does not affect the camera.

Another object of the present invention is to provide an image transmitting apparatus having a security function in which a heat sink is mounted at each of a main body and a lamp module so as to release the heat generated from the main body and the lamp module to the outside so that the lifespan of the main body and the lamp module can be extended, and in which an emergency call device including a microphone and a flashing light is provided separately so as to ensure that the emergency situation on the site is delivered.

To achieve the above objects, according to an exemplary embodiment of the present invention, there is provided an image transmitting apparatus having a security function, comprising:

a main body unit including a wireless or wired interface, a speaker, and an IP camera and having slide grooves formed in a horizontal direction at the upper and lower portions of both sides thereof; and

at least one lamp module including an LED lamp and having a slider formed protrudingly on a side thereof to correspond to each of the slide grooves, so that the slider is inserted into the each slide groove in the horizontal direction to cause the lamp module to be coupled to both sides of the main body unit.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a bottom perspective view illustrating an image transmitting apparatus according to an embodiment of the present invention;

FIG. 2 is a bottom view of FIG. 1;

FIG. 3 is a front view of FIG. 1;

FIG. 4 is an exploded perspective view of FIG. 1;

FIG. 5 is a block diagram illustrating the overall configuration of the image transmitting apparatus shown in FIG. 1; and

FIG. 6 is an exemplary view illustrating an image transmitting system using the image transmitting apparatus of FIG. 5.

[Explanation on symbols]

| | |
|---|---|
| 10: image transmitting apparatus | 100: main body unit |
| 102: heat sink | 104: slide groove |
| 106: retaining step | 120: IP CAMERA |
| 200, 300: lamp modules | 202, 302: sliders |
| 204, 304: projections | 206, 306: heat sinks |

### DESCRIPTION OF SPECIFIC EMBODIMENTS

Hereinafter, the configuration and operation of an image transmitting apparatus according to the present invention will be described in more detail with reference to the accompanying drawings.

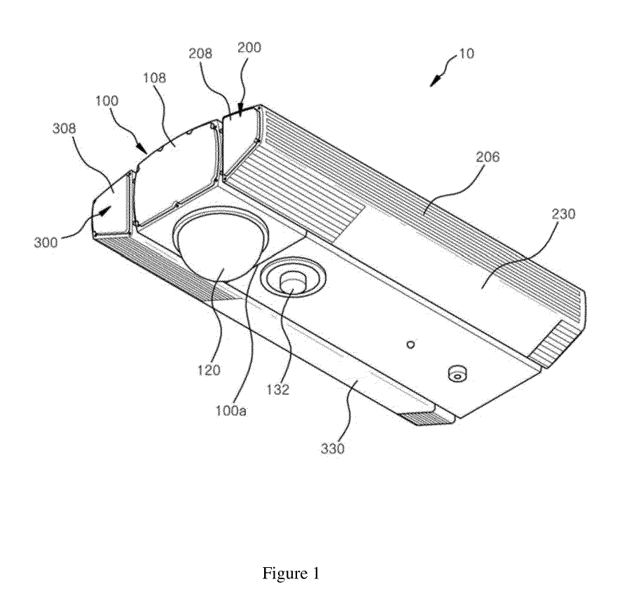

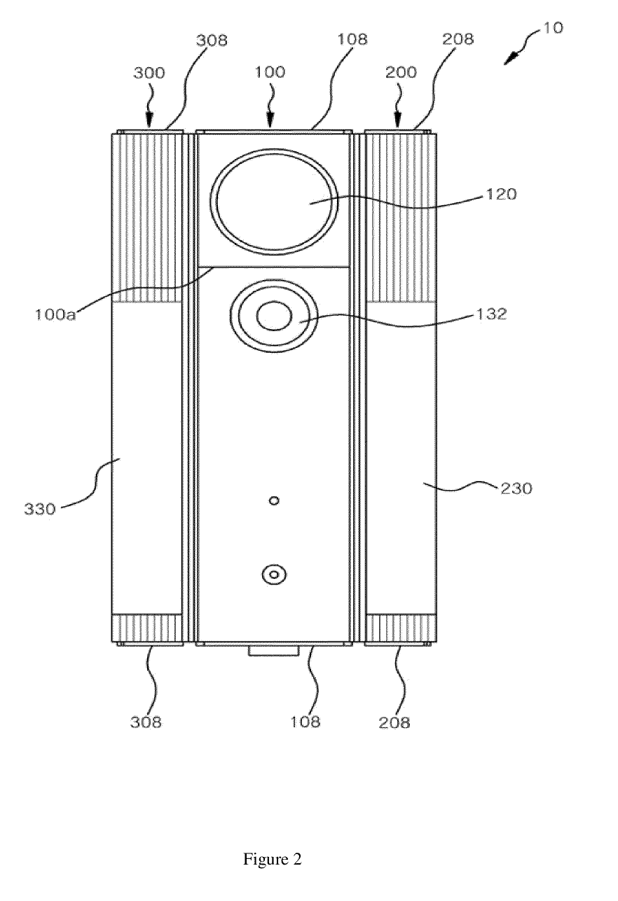

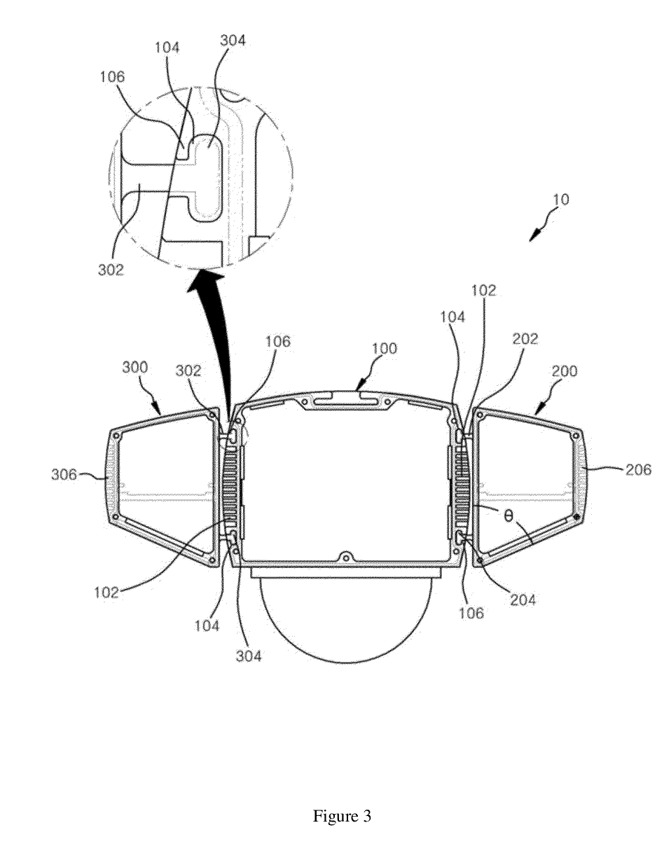

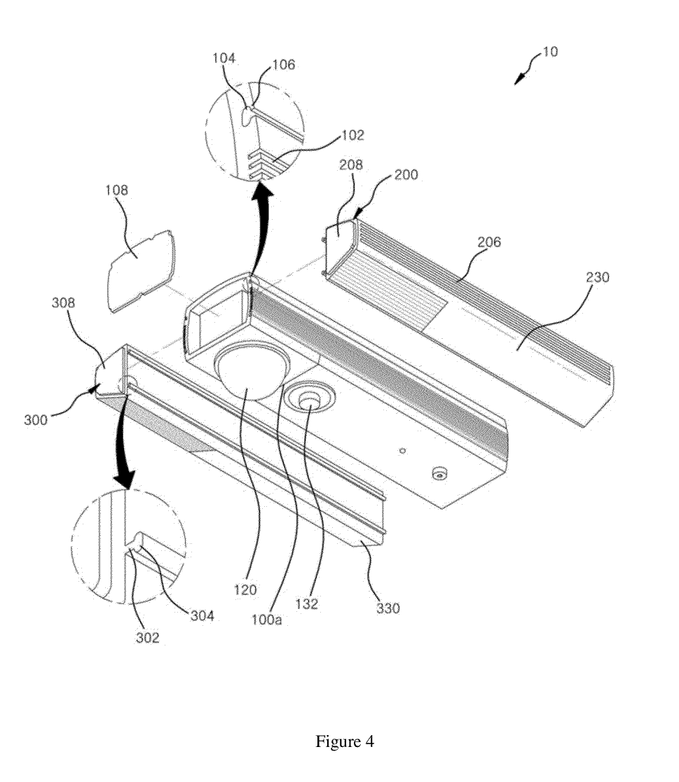

FIG. 1 is a bottom perspective view illustrating an image transmitting apparatus according to an embodiment of the present invention, FIG. 2 is a bottom view of FIG. 1, FIG. 3 is a front view of FIG. 1, and FIG. 4 is an exploded perspective view of FIG. 1.

Referring to FIGS. 1 to 4, an image transmitting apparatus 10 according to an embodiment of the present invention includes a main body unit 100 and a pair of lamp modules 200 and 300.

At an intermediate portion of each of both sides of the main body unit 100 is mounted a heat sink 102 that releases the heat generated from parts built in the main body unit 100 to the outside. A slide groove 104 is formed longitudinally in a horizontal direction at the upper and lower portions of both sides of the main body unit.

A retaining step 10 is respectively formed at both side walls of the main body unit 100 to correspond to an entrance side of the slide groove 104 so that the entrance of the slide groove 104 is narrow. In addition, a receiving portion of the slide groove 104 is formed large so that the slider 202 of the lamp module 200 is prevented from escaping to the outside in a state of being coupled to the slider groove 104 in the horizontal direction.

In addition, at the bottom of the main body unit 100 are mounted an IP camera 120 that photographs an image and a speaker 132 that outputs an audio signal.

Particularly, the bottom surface of the main body unit 100 on which the IP camera 120 is mounted is separated from the main body unit 100 based on a cut portion 100a, so that the IP camera portion only can be removed from the bottom surface of the main body unit 100 without any separation of the entire main body unit 100 for replacement with new one.

The IP camera 120 is a camera which enables a pan tilt zoom (PTZ) function to be performed. This IP camera 120 can be moved in both horizontal and vertical directions as well as the lens thereof can be operated to take an image of an object at a long distance or a short distance. The IP camera 120 can be controlled even at a remote place.

On the inner sides of the lamp modules 200 and 300 that confront the main body unit 100 are protrudingly formed sliders 202 and 302 so as to correspond the slide grooves 104. The ends of the sliders 202 and 302 are positioned in the receiving portion in a state of being inserted into the slide grooves 104. The ends of the sliders are formed with projections 204 and 304 so that the sliders are prevented from escaping to the outside from the slide grooves 104.

Heat sinks 206 and 306 are formed on the outer sides of the lamp modules 200 and 300 so as to release the heat generated from the inside of the lamp modules 200 and 300 to the outside.

Each of the lamp modules 200 and 300 includes LED lamps 230 and 330 arranged in rows and columns on a lower substrate thereof so as to illuminate a given area.

In this case, the number of the LED lamps 230 and 330 arranged is controlled depending on the watt of the lamp modules 200 and 300, and the bottom surfaces of the lamp modules 200 and 300 are inclined to be oriented toward the outside so as to prevent the light emitted from the lamp modules 200 and 300 from adversely affecting the IP camera 120.

The opened ends of the main body unit 100 and the lamp modules 200 and 300 are hermetically sealed by side covers 108, and 208 and 308.

In this above configuration, in a state in which the side cover 108 is not coupled to the one end of the main body unit 100, the sliders 202 and 302 of the lamp modules 200 and 300 are simply fittingly inserted into the slide grooves 104 formed on both sides of the main body unit 100 through the not-coupled one end of the main body unit 100, so that the lamp modules are simply coupled to the main body unit. Then, the side covers 108 is coupled to the opened one end of the main body unit 100 so that the image transmitting apparatus is easily and simply assembled.

In this case, if the side cover 108 is coupled to the main body unit 100 in a state in which the sliders 202 and 302 are inserted into the slide grooves 104 as the width of the side cover 108 is larger than the distance between the slide grooves 104, the lamp modules 200 and 300 do not needed to be fixed to prevent the lamp modules 200 and 300 from being moved.

After the completion of the assembly of the image transmitting apparatus, preferably, the positions of the lamp modules 200 and 300 coupled to the both sides of the main body unit 100 are set such that the lamp modules 200 and 300 maintain a distance of about 4 cm to 15 cm from the main body unit 100, the IP camera 120 maintains a distance of about 4 cm to 15 cm from the LED lamps, and the horizontal angle θ of the lamp modules 200 and 300 is set to have an inclined surface with an angle of 30° to 80° based on the center the main body unit 100, so that an effective image can be obtained to prevent the back light from the lamp modules 200 and 300 from being illuminated to the IP camera 120 while the heat generated from the main body unit 100 is effectively discharged to the outside by the heat sinks 104 of the main body unit 100.

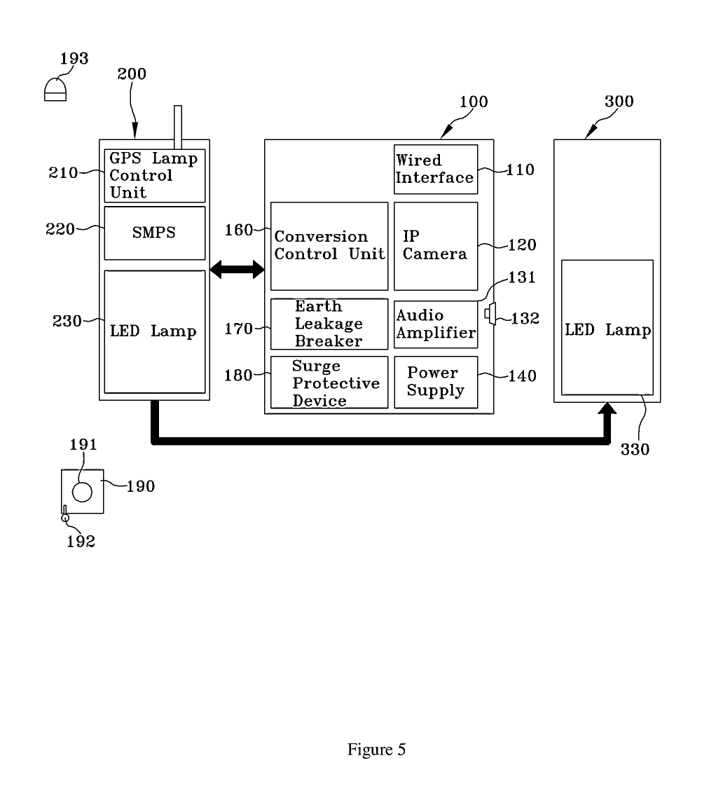

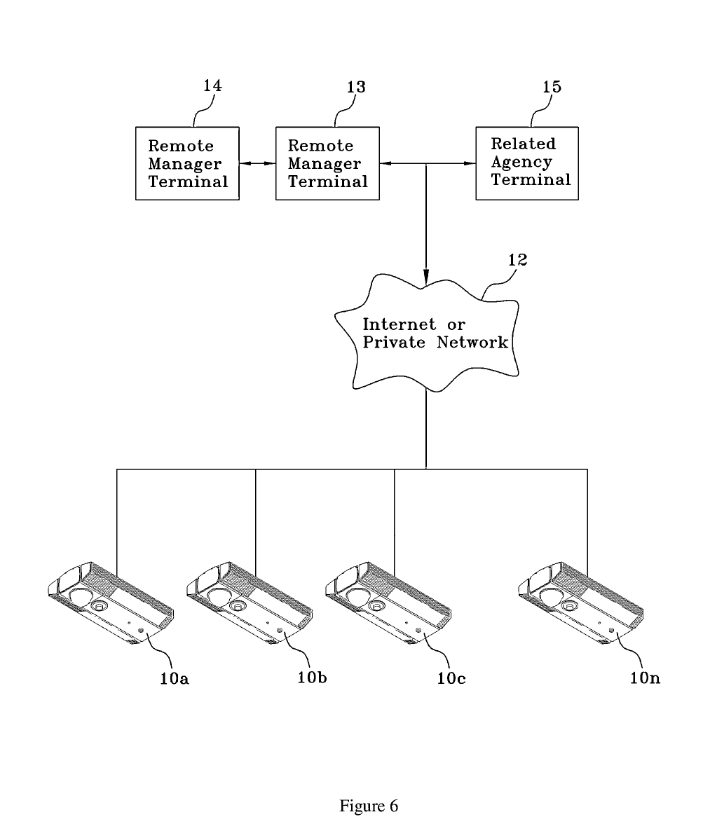

FIG. 5 is a block diagram illustrating the overall configuration of the image transmitting apparatus shown in FIG. 1, and FIG. 6 is an exemplary view illustrating an image transmitting system using the image transmitting apparatus of FIG. 5.

Referring to FIGS. 5 and 6, the image transmitting system includes a main body unit 100, two lamp modules 200 and 300, and an emergency call device 190.

The main body unit 100 includes a wired interface 110, an IP camera 120, an audio amplifier 131, a speaker 132, a power supply 140, a conversion control unit 160, an earth leakage breaker 170, and a surge protective device 180.

The IP camera 120 is mounted on the underside of the main body unit 100 to photograph an image. The IP camera 120 enables the PTZ function to be performed. In addition, the IP camera 120 includes a camera module, a position control unit, a decoder, an image compression chip, a CPU, and an IP server.

The wired interface 110 is connected to a remote manager terminal 14 through a remote manager server 13 connected thereto by the Internet or a private network 12 to transmit or receive information or a signal to or from the remote manager terminal 14. In addition, the wired interface 110 is connected to an IP server of the IP camera 120 and the conversion control unit 160.

The conversion control unit 160 is connected to the CPU of the IP camera 120, the IP server, and the wired interface 110.

The earth leakage breaker 170 is operated upon the occurrence of a short circuit, an electric leakage, or the like, and interrupts electric power supplied to the image transmitting apparatus 10.

The surge protective device 180 is used for the purpose of power supply and RJ-45 communication, and protects the image transmitting apparatus 10 from abnormal voltage, direct strike, and indirect strike introduced from the outside.

The audio amplifier 131 amplifies an audio signal inputted through the remote manager terminal 14, and the speaker 132 outputs the amplified audio signal as a sound.

The power supply 140 receives the supply of a commercial AC power and converts the voltage, and then supplies power to the respective elements of the main body unit 100.

Moreover, the LED lamps 230 and 330 are respectively mounted on the lamp modules 200 and 300 coupled to both sides of the main body unit 100, and the lamp module 200 at one side includes an SMPS 220 and a GPS lamp control unit 210.

The SMPS 220 converts the commercial AC power into DC power for application to the LED lamps 230 and 330. Also, the GPS lamp control unit 210 controls the turn-on and the turn-off of the LED lamps 230 and 330 based on information on latitude, longitude, and standard time, which are received through the GPS.

In addition, according to the present invention, an emergency call device 190 is further provided in single number or plural numbers at a low position which a person's hands can reach on an electric pole, a prop, or the like. In the case where the emergency call device 190 is operated on a wireless basis, the main body unit 100 may further include a wireless emergency call receiver that is operated in cooperation with the wireless emergency call device.

The emergency call device 190 includes an emergency bell 191 and a microphone 192. In addition, a flashing light 193 cooperating with the emergency call device 190 is mounted at a position different from the position where the emergency call device 190 is mounted.

The emergency bell 191 is intended to be depressed by a specified person who stays on the site of an emergency situation upon the occurrence of the emergency situation. When the specified person presses the emergency bell 191, the conversion control unit 160 detects this emergency situation for transmission to the remote manager terminal 14.

The microphone 192 receives the input of a surrounding sound and informs an emergency situation of the remote manager terminal 14 via voice upon the occurrence of the emergency situation.

The flashing light 193 is operated in cooperation with the microphone 192 and is turned on or off when an emergency situation is informed to the remote manager terminal 14 through the microphone 192 so that a specified person can check the informing of the emergency situation through the microphone 192.

As such, the microphone 192 is provided on the emergency call device 190 installed at a low position on a prop, or the like so that a specified person staying around the microphone 192 can accurately transfer the emergency situation to the remote manager terminal 14 without making a big sound.

In FIG. 6, the remote manager server 13 includes a wired interface that receives an image data, an audio data or an emergency call signal from the image transmitting apparatus through the Internet or the private network 12, an AV stream receiving unit, a control unit, a decoding unit, an image signal processing unit, an image display unit, an audio signal processing unit, a manager interface, and a storage.

The remote manager terminal 14 includes an Internet access unit that has an access to the Internet 12 through the remote manager server 13 and then receives an image data, an audio data, or an emergency call signal from the image transmitting apparatuses 10a, . . . , 10n, a manager interface, and an image display unit.

Further, when an emergency situation occurs, a related agency terminal 15 receives information on the emergency situation from the remote manager terminal 14 connected to the related agency terminal 15.

The related agency terminal 15 includes an Internet access unit, a manager interface, and an image display unit so as to receive an image data, an audio data, and related information from the remote manager server 13.

The operation of the image transmitting apparatus as constructed above will be described hereinafter.

The IP camera 120 photographs a target area and generates an image signal indicative of the photographed target area, and transmits the image signal to the conversion control unit 160 and the wired interface 110.

The position control unit included in the IP camera 120 receives a control signal from the conversion control unit 160, and controls the direction and zooming of the camera so as to obtain an effective image from a monitoring area.

The wired interface 110 transmits the control data of the conversion control unit 160 and the image data of the IP camera 120 to the remote manager server 13 through the Internet or the private network 12. Also, the wired interface 110 receives a signal from the remote manager server 13 for application to the conversion control unit 160 or the IP camera 120. Thus, the communication between the conversion control unit 160 and the IP camera 120 and the remote manager server 13 can be established and the image data of the IP camera 120 is transmitted to the remote manager server 13 under the control of the conversion control unit 160.

The conversion control unit 160 controls the transmission and reception of an emergency call signal and an audio signal, and delivery of information between the camera module and the wired interface in cooperation with a CPU and an IP server of the IP camera 120 and the wired interface 110.

By virtue of this, the conversion control unit 160 includes a remote camera control function of controlling the direction, distance, angle, etc., of a camera in the camera module, and an image data control function of the level, type, speed, etc., of the image data being encoded. In addition, the conversion control unit 160 controls the overall operation of the image transmitting apparatuses 10a, . . . , 10n in response to an instruction of a manager, which is inputted through the manager interface of the remote manager terminal 14.

In addition to this, the conversion control unit 160 further include a voice-detecting sensor (not shown) so that when the voice-detecting sensor detects a specific voice or a voice above a certain decibel (Db) level, it determines it as an emergency call signal and transmits the audio information to the remote manager terminal 14 through the wired interface 110.

Herein, a specific voice may be a voice such as, for example, “help me!”. An ordinary person's loud voice ranges from 80 dB to 110 dB, and thus when the voice-detecting sensor detects the voice, the conversion control unit 160 determines the detected voice as an emergency call signal and transmits the emergency call signal to the remote manager terminal 14 through the Internet or private network 12.

In addition, the conversion control unit 160 transmits a periodic control signal to the camera module based on a time table so as to periodically test whether or not the emergency call device 190 is operated, the camera outputs an image, and the camera is operated, and transmits a signal indicating whether or not the camera module is operated and is malfunctioned to the remote manager terminal 14.

Accordingly, the remote manager terminal 14 integratedly manages whether or not a plurality of emergency call devices 190 is operated and the camera module is malfunctioned.

Further, the conversion control unit 160 communicates with the remote manager server 13 and the related agency terminal 15 to receive and process various control commands or setting commands from the remote manager server 13 and the related agency terminal 15. In the meantime, when a specific person presses the emergency bell 191 upon the occurrence of an emergency situation, the conversion control unit 160 detects the emergency situation and transmits an emergency call signal to the remote manager terminal 14 through the wired interface 110. When the remote manager terminal 14 receives the emergency call signal from the conversion control unit 160, it generates an emergency call display and warning sound in real time.

At this time, the camera is directly oriented toward the emergency call device 190, i.e., the call direction by the position control unit of the IP camera 120. Moreover, since an identification number has been assigned to each of the image transmitting apparatuses 10a, . . . , 10n, the image transmitting apparatuses 10a, . . . , 10n located within a predetermined range can simultaneously watch the area where the emergency call signal is generated and can collect information.

That is, in the case where an emergency situation occurs, the IP cameras of the image transmitting apparatuses 10a, . . . , 10n located within a predetermined range photograph the area where the emergency call signal is generated, so that for example, the image transmitting apparatuses 10a, . . . , 10n can collect various items of information on what a criminal looks like and what he or she is wearing, the direction in which the criminal flees, and the like, and can deliver image information or position information to the related agencies.

Also, in the case where a remote manager identifies the image taken from the IP camera 120, the audio data inputted through the microphone 192, and the emergency call signal generated by the emergency bell 191, when he or she inputs the audio data through the remote manager terminal 14, a guide or warning broadcast is outputted via the Internet or private network 12 and the speaker 132 as a countermeasure.

Although there has been illustrated that the image transmitting apparatuses are connected with each other through the Internet, the respective image transmitting apparatuses may be connected with each other on a wireless basis. In this case, a wireless interface such as a binary CDMA module is provided as a connection means instead of the wired interface 110.

As described above, according to the image transmitting apparatus of the present invention, the image-transmitting apparatus can illuminate a large area, the lamp module can be easily separated from the main body unit and can be repaired upon the occurrence of a fault in the lamp module, and the images captured by the camera are made clear as light emitted by the lamp does not affect the camera.

In addition, a heat sink is mounted at each of the main body and the lamp module so as to release the heat generated from the main body and the lamp module to the outside so that the lifespan of the main body and the lamp module can be extended, and the emergency call device including a microphone and a flashing light is provided separately so as to ensure that the emergency situation on the site is delivered. Further, only a camera portion is separately removed from the main body unit for replacement with new one without disassembling the main body unit upon the occurrence of a fault in the camera

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical spirit of the appended claims.

1. An image transmitting apparatus having a security function, the image transmitting apparatus comprising:
a main body unit including a wireless or wired interface, a speaker, and an IP camera and having slide grooves formed in a horizontal direction at the upper and lower portions of both sides thereof; and
at least one lamp module including an LED lamp and having a slider formed protrudingly on a side thereof to correspond to each of the slide grooves so that the slider is inserted into the each slide groove in the horizontal direction to cause the lamp module to be coupled to both sides of the main body unit.

2. The image transmitting apparatus according to claim 1, wherein the main body unit includes a retaining step formed at at both side walls thereof to correspond to an entrance side of the slide groove, and the slider has a projection formed at an end thereof, so that the slider is prevented from escaping from the slider groove to the outside in a state of being inserted into the slider groove.

3. The image transmitting apparatus according to claim 1, wherein a heat sink is mounted between the slide grooves formed at the upper and lower portions of both sides of the main body unit, and at the outer surfaces of the lamp modules, which are opposed to the inner surfaces formed with the sliders so that the heat generated from the main body unit and the lamp modules is released to the outside.

4. The image transmitting apparatus according to claim 3, wherein the main body unit and the lamp module are coupled to each other in such a manner as to be spaced apart from each other by a predetermined distance, the horizontal angle of the lamp module is 30° to 80° based on the center the main body unit 100.

5. The image transmitting apparatus according to claim 1, further comprising: an emergency call device including an emergency bell and a microphone, and a flashing light operated in cooperation with the emergency call device, the emergency call device and the flashing light being configured independently of the main body unit.

6. The image transmitting apparatus according to claim 1, wherein the width of a side cover for closing the opened end of the main body unit is larger than the distance between the slide grooves formed at both sides of the main body unit.

7. The image transmitting apparatus according to claim 2, wherein the bottom surface of the main body unit on which the IP camera is mounted is separated from the main body unit based on a cut portion.

8. The image transmitting apparatus according to claim 2, wherein a heat sink is mounted between the slide grooves formed at the upper and lower portions of both sides of the main body unit, and at the outer surfaces of the lamp modules, which are opposed to the inner surfaces formed with the sliders so that the heat generated from the main body unit and the lamp modules is released to the outside.
